(19) United States
(12) Patent Application Publication
(10) Pub. No.: US 2004/0254829 A1
(43) Pub. Date: Dec. 16, 2004

(54) Wireless access data sharing system

(76) Inventor: Jeffrey William Tripp, Annandale, NJ (US)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/842,817

(22) Filed: May 11, 2004

Related U.S. Application Data
(60) Provisional application No. 60/469,902, filed on May 13, 2003.

(51) Int. Cl. G06F 17/60

(52) U.S. Cl. 705/10

(57) ABSTRACT

A means/product seamlessly gathers and retains data for consumer products and services to enable e-commerce in handheld devices. Data is available at the product and rich enough in content to provide details about the product or service for use in the purchasing decision of the consumer or immediately allow access to additional information through a wireless connection. In one embodiment, the solution utilizes RFID tag technology.

### CROSS-REFERENCE TO RELATED APPLICATIONS

The present application claims priority of U.S. Provisional Patent Application Ser. No. 60/469,902 filed May 13, 2003, the entire disclosure of which is incorporated by reference herein.

### BACKGROUND OF THE INVENTION

There exists an application for RFID technology that has gone unnoticed and provides a business opportunity to create products for the consumer market that complements the efforts of the retailers and enables efficient electronic/mobile commerce (e-commerce) opportunities. This application will provide consumers with valuable point of service information and will support the retailers' efficiency goals and the manufacturers brand awareness, while providing technical simplicity and helping to create more value for RFID devices by creating the broadest application of the technology that is possible. The following information is an overview of this new business opportunity.

It is possible to create a product and service to leverage the deployment of the next generation RFID tags and provide consumers with a simple, affordable, and interactive wireless data link to download product specifications or information to handheld devices seamlessly, while providing retailers with an efficient mode of e-commerce.

### SUMMARY OF THE INVENTION

Consumers have many handheld devices available that can be used to store data and information or access information remotely. Today, this information is stored in a detached way for close association for the consumer to use effectively or in not enough detail to prove effective. If more information was immediately and seamlessly available for the consumer, this data could be used to provide details about products, enhance services, or provide directions. Having this information would create more awareness for the consumer and allow for faster purchasing decisions to be made. Allowing products to be updated with this latest information can assist the product marketing teams in point of sale advertising and provide a new tool in their quest to optimize the product flow through the channels.

The following introduces a concept for information gathering and applications for its use. The information is focused on products, although, there are service applications and business opportunities also available, as previously discussed. The technological aspects will be discussed in the following section. In general, the use of existing technological devices is used in a new way creating a novel device and application.

### BRIEF DESCRIPTION OF THE DRAWINGS

FIG. 1 is an exemplary diagram in accordance with an embodiment of the present invention.

FIG. 2 is an exemplary diagram in accordance with an embodiment of the present invention.

FIG. 3 is an exemplary diagram in accordance with an embodiment of the present invention.

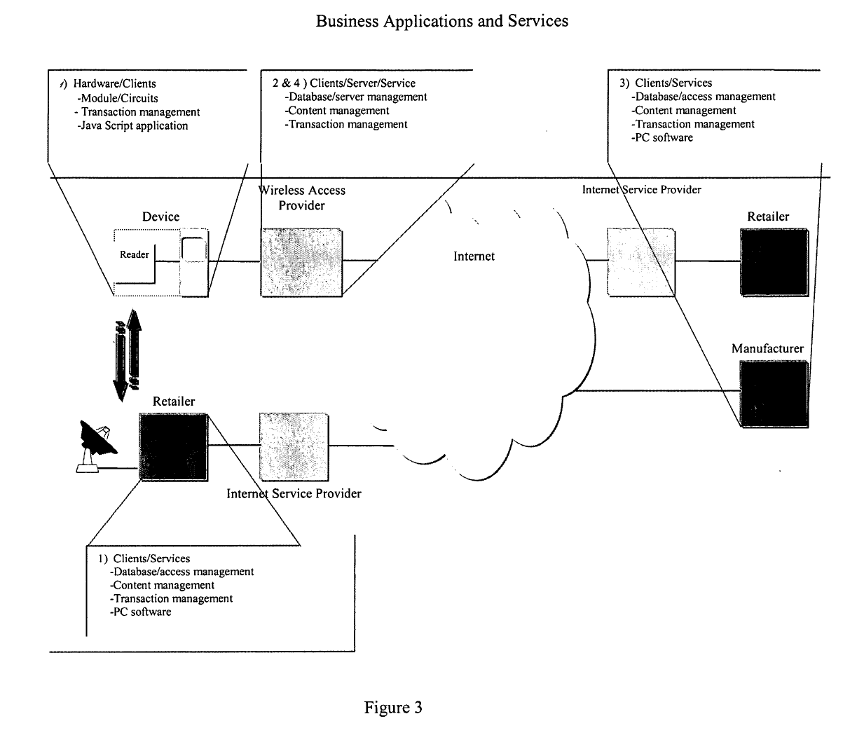

FIG. 4 is an exemplary block diagram in accordance with an embodiment of the present invention.

### DETAILED DESCRIPTION

It is proposed to introduce a means/product to seamlessly gather and retain data for consumer product and services to enable e-commerce in handheld devices. Data would be immediately available at the product and be rich enough in content to provide details about the product or service for use in the purchasing decision of the consumer or immediately allow access to additional information through a wireless connection. The proposed solution would tap into the emerging RFID tag technology. The consumer would either purchase add-on products for wireless products such as PDA's, (portable handheld devices) and cellular phones or purchase a handset with access capability included. The modules would interface directly to these handheld devices, tapping into an already embedded base. The consumer, on demand, would operate the devices/reader. This would be accomplished by having the consumer approach a product of interest and wave their handheld device near the product to extract the information provided. The data would be loaded into the handheld unit for review, storage, or seamless data access through a wireless data link. The transaction is simple and efficient, but yet provides information to the consumer that could be valuable in making a purchase, at the point of sale.

Manufacturers or retailers would embed/attach RFID tags into their products. As the devices are programmable, the both the retailer or the manufacturer could modify the contents of the device to provide up to date information about a product that would be useful to the consumer on top of the baseline information such as product features, model numbers, etc. In fact, the RFID tags memory can be scaled to provide increasing content for more sophisticated or expensive items. Additionally, the client software would also create a data link, allowing the consumer to immediately access more information. All of this would take place automatically, after the consumer decides to look for additional information.

The retailer and manufacturer would now have at their disposal, a powerful new marketing tool. Now that information can be updated in real-time for the consumer, marketing teams can test different forms of content at the point of sale to sway the thoughts of the consumer.

To promote the use of this e-commerce method the new business would design ID readers to be integrated or added onto portable handheld devices. This would provide consumers to have this option available in many forms such as mobile phones, personal PDA's or possibly shopping carts with readers embedded. To implement this concept,

1) Reader and the associated content in the RFID tag

2) Client software residing on the handheld device

3) Carrier grade software to create efficient data connections

4) Database service and web-based database software.

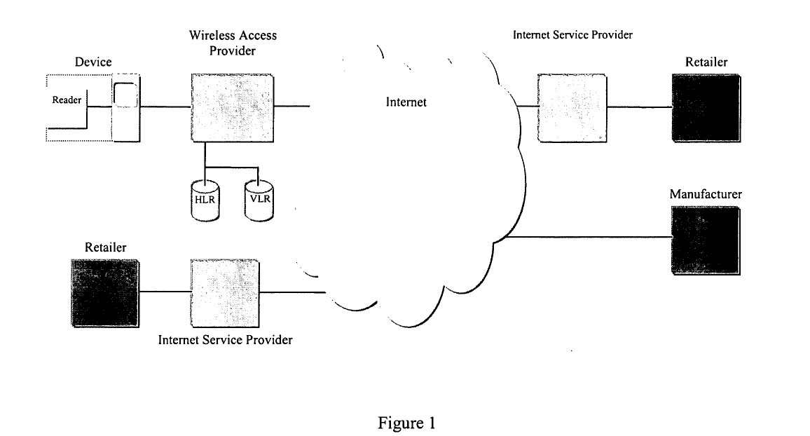

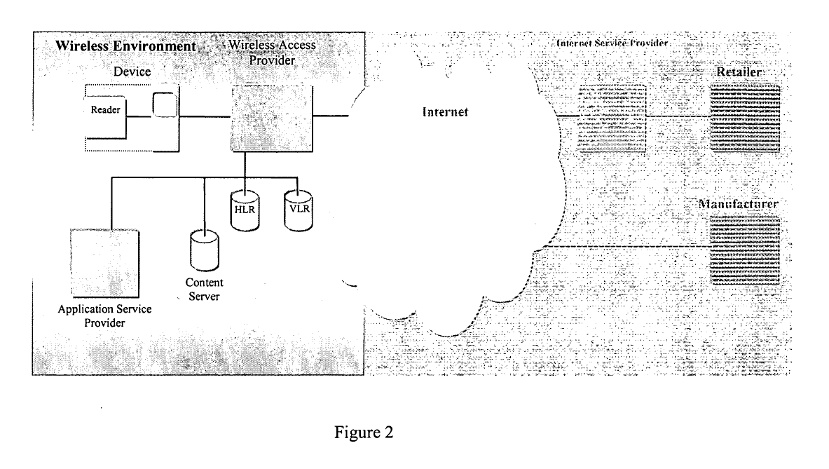

FIG. 1 is a simple system representation. Contained within the Internet cloud are the routers and access devices that create the connections throughout the network. As this business is developed, it is important to recognize that several operating environments exist and must be addressed. The Wireless environment is represented in FIG. 2 and includes a portable wireless device that contains the ability to read RFID devices, a software client to interpret and display the information and it has access/connection to a cellular network (like GSM, CDMA, TDMA, W-CDMA, . . . ).

In this system, as the user reads RFID devices/tags, information is presented that requires additional access to information stored remotely to the handheld device. As the user traverses the menu tree, more entities may be required to provide additional content or services. If the user is interested in obtaining greater content, the user can then choose to move outside the local domain and access content contained further in the overall system or the Wireless Environment. In this case, the wireless access provider can choose to provide additional information through services or content resident on the network. Therefore, both an application service provider and a content server have been added to the system. The service provider allows access to additional data through their portals by providing the increased capability and service purchased. As the service provider allows access to their clientele base and certify applications/content providers on the system, they will be able to conduct transactions for those providers. As a central clearing house, they will then provide for secure transactions and billing through their system. As content providers, manufacturers, and retailers desire access to the service providers' data base, the user community will grow and additional revenue will be gained through increased airtime and services. Therefore, additional clients and servers will be made available to provide this capability and service this need.

Finally, as the user demands greater and greater seamless content, the global environment will be entered. At this level, there is a wide range of software and services to be offered. As access encompasses all entities including the retailers and manufacturers, client software or services is required to allow efficient use of this new capability. As users seamlessly enter into this environment, applications can range from information exchange to video clip demonstrations to live broadcasts with video. This is dependent upon the level of service required by each entity. This service or provisioning is again addressed by client software, but will also include consulting services with both technical and marketing capabilities to provide a full service to the ultimate content providers. Maintenance and access to data bases to support these activities must be provided and connected seamlessly.

It is appropriate then to develop and offer multiple levels of service and software to support the many varied applications for this business. Software clients/applications will be available for the manufacturer and retailer to access data bases of product information or content, included in this will be the capability to format, design and scale the content to work reliable with the limited displays available on handheld devices. Also, this software will be secure and capable of conducting transactions directly to these entities. Software will be made available to format the data and program devices from any access point. Agreements between retailers and manufacturers can then be constructed to allow direct access to products in retail outlets to program marketing content.

It was demonstrated that a technology could be developed to deliver new and unique products and services to the consumer. The system is flexible and lends itself to leverage future technical advances enhancing the capabilities and potential of the entire system.

The wireless access environment may provide and allow the greatest opportunity for this technology. Access through the wireless service providers provides limitless data content and enables a greater number of businesses to participate in the system. Referring to the system in FIG. 1, the wireless access environment can be served through adding client software, servers, and services. The server can exist in any of three different spaces with the client as the driver. The server can be deployed by either the wireless provider, by application service providers, or by the business as a service. To use the system, the RFID tag and client reader in the handheld device is mapped to a specific location on the network (if additional content is requested from the consumer). From this location or appropriate content mapping takes place either locally or through the Internet. The wireless access provider now has a new application to generate additional revenues. The service provider would package this as a feature on the system and charge a monthly fee, for example, to enable the capability on a consumer's handheld device. This can be provisioned through the system to the desired handheld device. Additionally, with this technology it will be easy for the wireless service provider to become the central point for many transactions and earn additional revenues by creating this capability in the environment. Appropriate secure transaction software is employed along with database exchanges between the consumer, the retailer and the service provider, but the service provider has the ability to charge through their purchases to the subscriber via a monthly billing process for example. As the service provider considers future partnerships, an opportunity exists to gain further revenues through credit card charges in partnership with a banking function.

The network software-pricing model will consist of several elements. First, a client will exist in the network to conduct the transaction between the handheld and the network. Every network that desires access to this system will be required to carry this client. Further, a database management tool is required on a server to either access content contained within the wireless environment or to access elements that require transactions through the internet. The client software will be based upon network distribution and optimization. Multiple data base management devices will be required as content is routed and saved throughout a wireless network and the application service providers. The larger and more distributed the network elements, the more sophisticated the software will need to become. This will be a multi-server based system to create fast links between appropriate elements and the consumer handheld.

One of the most important features within each of the environments is the ability to provide the individual consumer with information at the time of a purchase decision. The goal of the retailer is to increase sales, while the goal of the manufacturer would be to influence the product selection. The service provider benefits through increased usage on their system and access to the mobile consumer. The mobile consumer benefits by obtaining information pertaining to desired decision points and the satisfaction of making an educated purchase.

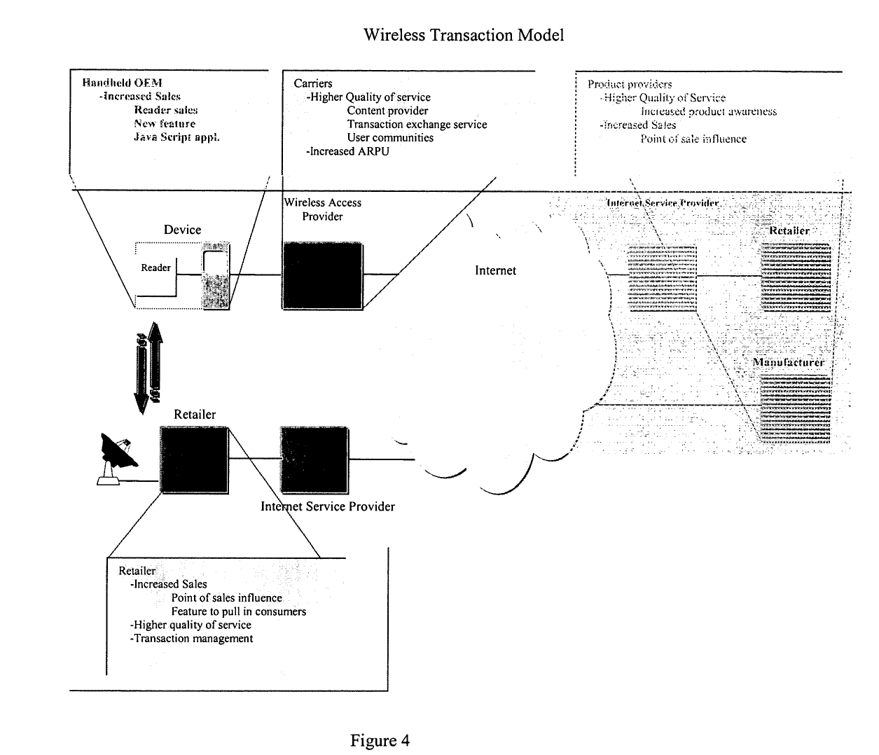

The Wireless environment is outline in FIG. 4. This environment is probably the most dynamic opportunity available as the wireless service provider creates a centralized point for content management and controls access to the subscriber base through unique methods. The wireless provider is unique because mobile consumers have never had access to any free content on their handheld device. All content costs at least the price of an SMS or phone call. Another huge difference between the Internet and the mobile sector is that the Wireless providers are already billing customers and any new content can simply be billed on the consumers' monthly phone bill. Further, this allows Wireless provider the ability to create method to conduct transactions and represent not only the content providers, but bridge the gap between manufacturers, retailers and consumers.

Additionally, as the Wireless service providers strive to create a user community, new features will need to be created. The user community will not only focus in towards direct subscriber services, but point out to access information through retailers, content providers and retailers. Creating the community requires certification to which the Wireless provider negotiates.

The retailers can also be a part of the wireless community. Instead of maintaining a local environment, both the consumer and the retailer can enable access through the wireless access and join the community either to access greater content or create additional transactions. Further, it is possible to have the wireless provider administer the transaction through a service, to allow the community users a more convenient method of purchasing.

As in each environment, one of the most important attributes of the system is the ability to individually market to the consumer. This intimate ability enabled by the consumer is a powerful method to enhance the opportunity to complete sales and increase the bottom line. A business entity could use this for presenting the appropriate information for a new product introduction or improve overall customer satisfaction for ongoing campaigns.

Overall, the system outlined, provides enhanced revenue opportunities for businesses by accelerating consumer purchases in the market.

Although the invention has been described in terms of exemplary embodiments, it is not limited thereto. It will also be appreciated that a system in accordance with the invention can be constructed in whole or in part from special purpose hardware or from conventional general purpose hardware or any combination thereof, any portion of which may be controlled by a suitable program. Any program may in whole or in part comprise part of or be stored on a system in a conventional manner, or remain whole or in part be provided into the system over a network or other mechanism for transferring information in a conventional manner. Accordingly, it is understood that the above description of the present invention is susceptible to considerable modifications, changes and adaptation by those skilled in the art, and that such modifications, changes and adaptations are intended to be considered within the scope of the present invention, which is set forth by the appended claims. The invention having been described, it will be apparent to those skilled in the art that the same may be varied in many ways without departing from the spirit and scope of the invention. Any and all such modifications are intended to be included within the scope of the following claims.

What is claimed is:

1. A communication system comprising:
one or more RFID devices storing information;
one or more portable wireless devices reading the information stored on the RFID devices; and
a cellular network accessible by the portable wireless devices in response to the information to access remote information.

2. A communication system of claim 1, wherein the cellular network comprises one or more selected from the group consisting of GSM, CDMA, W-CDMA, OFDM, UWB, 802.16, 802.1x, WiMax, ZigBee and Bluetooth.

3. A communication system of claim 1 further comprising:
One or more software clients for creating a communication link from the RFID devices to the portable wireless devices.

4. A communication system of claim 3 further comprising:
One or more software clients creating a communication link from the portable wireless device through the cellular network.

5. A communication system of claim 4 further comprising:
One or more remote data bases storing the remote information, with the remote information comprising product information or content.

6. A communication system of claim 5 further comprising:
A server deployed on the cellular network for creating links to the remote information.

7. A method for providing a service to connect or match product information relevant to information stored on an RFID tag through a cellular connection of a communication device.

8. A method according to claim 7, wherein the cellular connection comprises an internet connection to access the stored information; the method further comprising:
registering of information to create an association to information stored on the RFID tag.

9. A method according to claim 7 further comprising:
updating of information in the association or the RFID tag for marketing to a consumer through a portable wireless device.

10. A method comprising an RFID tag and a handheld device, with the handheld device having an interface for requesting information and a client reader, wherein the client reader regulates communication over a network according to information requested via the interface and creates a link to at least one of either a local data source or a remote data source.

11. A method to provide a service for a wireless service provider based on communication between an RFID tag and a handheld device, with the handheld device having an interface for a consumer to request information and a client reader, wherein the client reader regulates communication over a network according to information requested via the interface and creates a link to at least one of either a local data source or a remote data source, wherein the wireless service provider charges a fee in connection with the communication.

12. A method according to claim 11, further comprising:
creating charges based on categories of information requested.

13. A method according to claim 11, further comprising enabling purchases of products or services via a billing process.
